(19) United States
(12) Patent Application Publication
(10) Pub. No.: US 2001/0047250 A1
(43) Pub. Date: Nov. 29, 2001

(54) Interactive decorating system

(76) Inventors: Joan A. Schuller, Gladwyne, PA (US); Harry Dee Washington JR., Newark, DE (US); Deborah Zimmer, Richboro, PA (US); John G. Stauffer, Wallingford, PA (US); Kelly Fong, Woodside, NY (US); Nina Collart, San Francisco, CA (US); Yeshayah Artsy, Nashua, NH (US); Keith Kwok, Sunnyside, NY (US); Peter Thomas, Paramus, NJ (US)

Correspondence Address: MENDELSOHN AND ASSOCIATES PC, 1515 MARKET STREET, SUITE 715, PHILADELPHIA, PA, 19102, US

(21) Appl. No.: 09/775,926

(22) Filed: Feb. 2, 2001

Related U.S. Application Data
(60) Provisional application No. 60/181,491, filed on Feb. 10, 2000.

(51) Int. Cl. G06F 17/50

(52) U.S. Cl. 703/1

(57) ABSTRACT

A computer-implemented method of visualizing a decorating project includes rendering an image of a building space (e.g., a room) that includes a number of structural objects (such as doors, walls, and furniture). The structural objects may be portrayed in the rendered image with visual characteristics that are determined by decorative materials (such as paint, fabric, or wallpaper) associated with the objects. The decorative material associated with a particular structural object may be determined based on user input selecting an object's decorative material from a group of available decorative materials. The method may also include generating a listing of selected decorative materials (e.g., for use in a subsequent decorating session) and sending the listing to a purchasing system. A computer-implemented decorating system includes a server operatively coupled to a memory, a database, and to a network over which data can be exchanged with client computers. The memory includes software instructions to configure the server to retrieve modeling software from the database in response to requests from client computers and to send the modeling software over the network to the client computers. The modeling software includes instructions to configure the client computers to model structural objects, to associate decorative materials with the structural objects, and to render an image of a building space. The rendered image portrays structural objects in accordance with visual characteristic of associated decorative materials.

### CROSS-REFERENCE TO RELATED APPLICATIONS

This application claims the benefit of the filing date of U.S. provisional application no. 60/181,491, filed on Feb. 10, 2000.

### BACKGROUND OF THE INVENTION

1. Field of the Invention

The present invention relates to Internet-based web sites that enable users to decorate spaces, like rooms in a house.

2. Description of the Related Art

When decorating a home, office, or other building space, decorators seek to combine architectural styles, furnishings, colors, and patterns to achieve an aesthetically pleasing result. In addition to achieving an aesthetically pleasing result, decorators typically want a result that reflects their (or a client's) personal taste and which may incorporate their unique aesthetic views. However, decorators may be hesitant to try new combinations or to stray too far from known designs due to their inability to accurately predict how a combination of styles and decorating options will look. As a result they may limit their decorating projects. From the standpoint of a decorating materials provider, this may result in a lost revenue opportunity. A system that allows a decorator to visualize the results of a decorating project prior to implementing the project can provide advantages to the decorator as well as to product salespersons, manufacturers, and others.

### SUMMARY OF THE INVENTION

The invention includes systems and methods that can help a user plan, visualize, and implement a decorating project. In general, in one aspect, the invention features a computer-implemented method of visualizing a decorating project. The method includes rendering an image of a building space (e.g., a room) that includes a number of structural objects (such as doors, walls, and furniture). The structural objects may be portrayed in the rendered image with visual characteristics that are determined by decorative materials (such as paint, fabric, or wallpaper) associated with the objects. The decorative material associated with a particular structural object may be determined based on user input selecting an object's decorative material from a group of available decorative materials. The method may also include generating a listing of selected decorative materials and sending the listing to a purchasing system.

In general, in another aspect, the invention features a computer-implemented method for visualizing a decorating project. The method includes querying a database to obtain structural object data records in response to a data request from a client computer, transmitting the structural object data records to the client computer, querying the database to determine decorative material data records associated with the structural object data records, and transmitting the decorative material data records to the client computer.

In general, in another aspect, the invention features a computer-implemented decorating system. The system includes a server operatively coupled to a memory, a database, and to a network over which data can be exchanged with a plurality of client computers. The memory includes software instructions to configure the server to retrieve modeling software from the database in response to a request from a client computer and to send the modeling software over the network to the client computer. The modeling software includes instructions to configure the client computer to model structural objects, to associate decorative materials with the structural objects, and to render an image of a building space. The rendered image portrays structural objects in accordance with visual characteristics of associated decorative materials.

Implementations may include one or more of the following features. The decorative materials that are associated with structural objects can be changed and a new image of the building space rendered. Data providing for three-dimensional models of the structural objects may be obtained from a database and used to render the structural objects. Data representing visual characteristics of the decorative materials may be retrieved from a database and mapped to the 3D models when rendering the image of the building space. The system can include automatic matching of a sample material to a decorative material in the database based on an input image of the sample material. The input image may be obtained using a digital image capture device such as a scanner, digital camera, or video signal capture device and the matching decorative materials may be determined by comparing colors, patterns, or other visual characteristic data associated with the decorative materials and the input image. Identifiers of decorative material samples in a physical sample chart may be displayed to the user.

Implementations also may include downloading modeling software from a server to configure the computer to receive the user input, associate decorative materials with structural objects, render the image of the building space, generate the listing, and transmit the listing to the purchasing system. The modeling software can be executed at the computer using a virtual machine, e.g., the modeling software may be a Java® program executed using a Java Virtual Machine.

In one embodiment, the present invention is a method for enabling a user to perform a decorating session for a space, comprising the steps of (a) receiving, at a web server, a request from a remote client computer for access to a decorating web site supported by the web server; and (b) transmitting, in response to the request, software from the web server to the client computer, wherein, when executed on the client computer, the software enables the user to perform the decorating session for the space.

In another embodiment, the present invention is a method for enabling a user to perform a decorating session for a space, comprising the steps of (a) receiving, at a web server, a request from a remote client computer for access to a decorating web site supported by the web server; and (b) executing, in response to the request, software to enable the user to perform the decorating session for the space, wherein, during the decorating session, the user is able to (i) select one or more structural objects from a plurality of available structural objects for display in the space; and (ii) select a decorative material from a plurality of available decorative materials to be applied to each selected structural object independent of the decorative materials selected for any other structural object.

### BRIEF DESCRIPTION OF THE DRAWINGS

Other aspects, features, and advantages of the present invention will become more fully apparent from the following detailed description, the appended claims, and the accompanying drawings in which:

FIG. 1 shows a block diagram of a computer network;

FIG. 2 shows a block diagram of a web server computer;

FIGS. 3-4 show flowcharts of exemplary design application operations;

FIG. 5 shows an exchange of messages between a web server and a client; and

FIGS. 6A, 6B, and 6C show different views of a software interface.

### DETAILED DESCRIPTION

In the field of computer-generated imaging (CGI), techniques are known for the realistic simulation of objects (including color, shape, and construction) on a graphic visual input/output device, such as a cathode ray terminal (CRT). For example, an engineer may use a computer-aided design (CAD) system to simulate an image of a car prior to building the car. Improvements in visualizing the results of a decorating project can be provided by applying CGI techniques as an element of a decorating system.

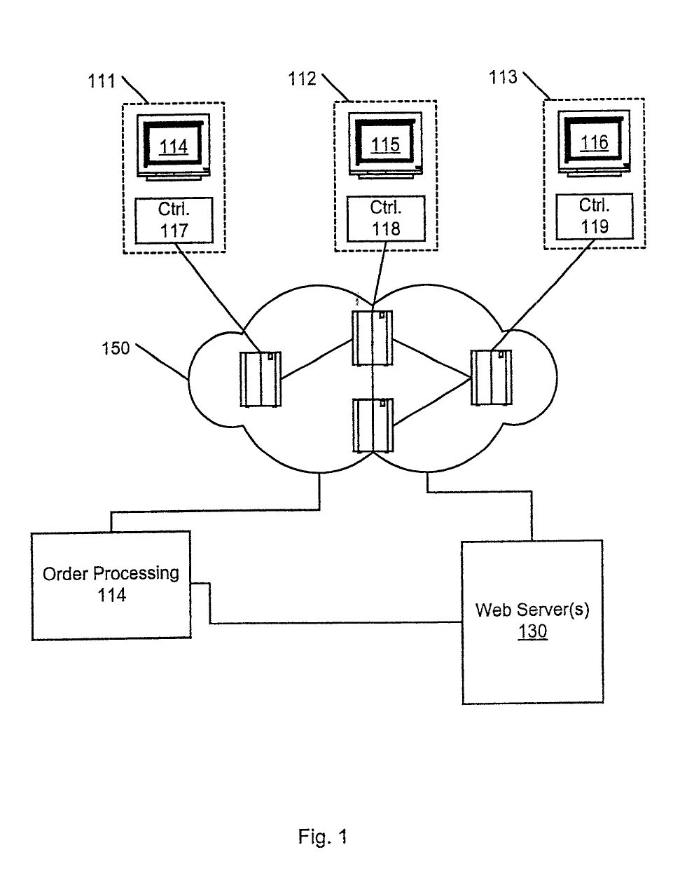

FIG. 1 shows a computer network 100 that include a world wide web server 130 and web client computers 111-113. The server 130 and clients 111-113 include software implementing the Hypertext Transfer Protocol (HTTP), which can be used to exchange data over the Internet 150 (or other network). Web server 130 can process and generate data and can operate as a data repository. Data stored at, and/or generated by, the server 130 can be retrieved by the web clients 111-113, processed, and presented to users. Processing and presentation of the retrieved data may be performed by web browser software such as Microsoft Internet Explorer Version 5.0 or greater or Netscape Navigator Version 4.0 or greater. Data processing and presentation by a browser may conform to requirements of standardized data formatting protocols, such as the Hypertext Markup Language (HTML) or Extensible Markup Language (XML). In addition, browsers may provide for the download and execution of software, such as through the use of a Java® Virtual Machine implementing Java programs. Other data formatting and presentation protocols, other programming languages, and rich media data such as audio, video, and animation files also can be exchanged between the server and clients and processed by browser software or other client software.

A web server 130 and client computers 111-113 can operate as components of a computer-based decorating system (“the decorating system”). The decorating system can be used to design and decorate a room of a house or other building space. In addition, in some implementations, the decorating system can further assist in a design and decorating project by automatically generating a list of materials needed to implement a particular design and decorating scheme and, through an interface to an automated ordering system, to assist a user in purchasing needed materials.

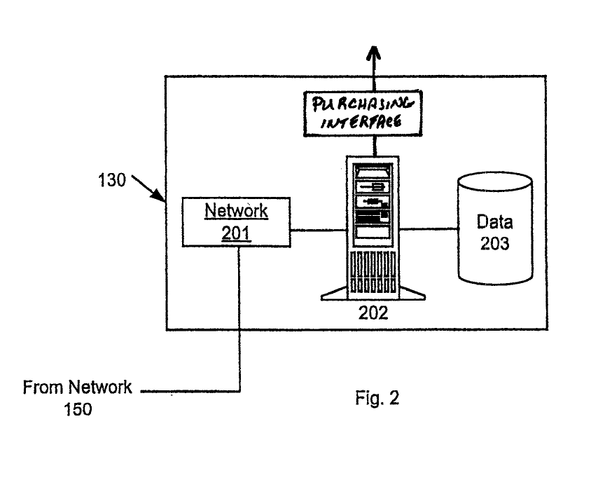

A computer-implemented decorating system can be hosted by web server 130 that is accessed by web client computers 111-113. FIG. 2 shows, in block diagram form, additional details of web server 130 which operates as part of the decorating system. The web server 130 includes a network interface 201, a processor 202, and a database 203. The web server also may include an interface 204 linking the server to a purchase ordering processing system 114. Components 201-204 of server 130 may be implemented using industry-standard computer hardware and software and may be implemented as sub-components of a single computer or may be distributed among one or more server computers. The web server 130 can be software configured to respond to HTTP requests and to process data from the web clients. Suitable HTTP request and transaction processing software is available from software vendors such as Microsoft, Netscape, Sun, and Lotus. Other programs, such as the “freeware” Apache web server and custom-developed software also can be used.

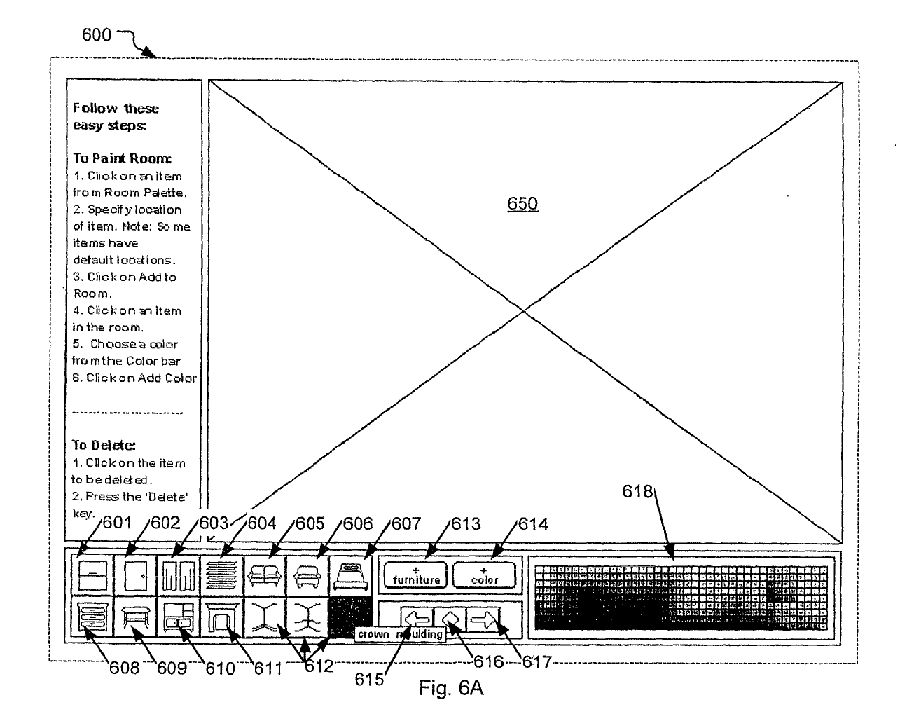

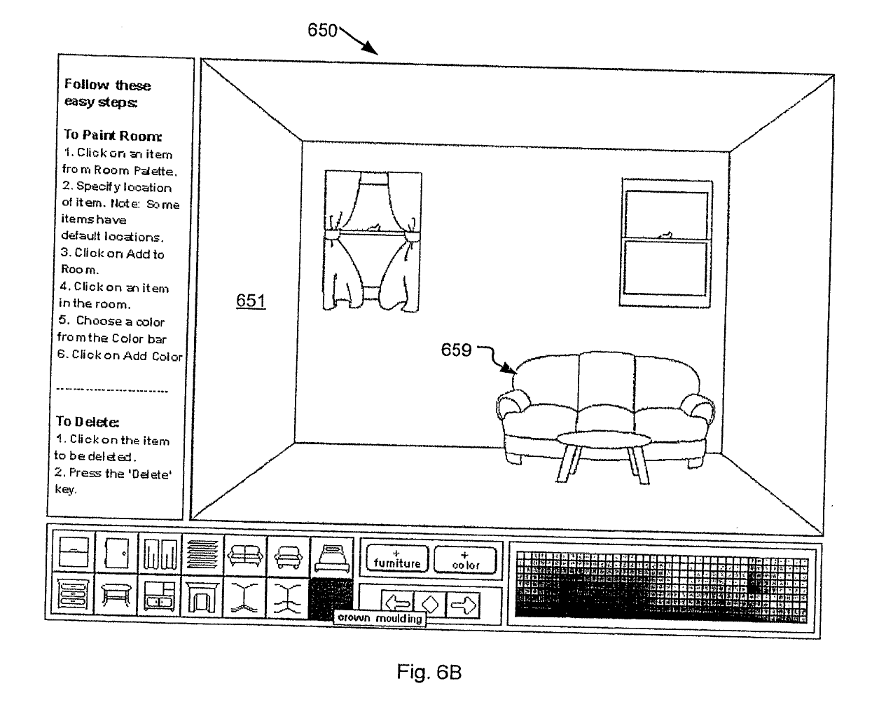

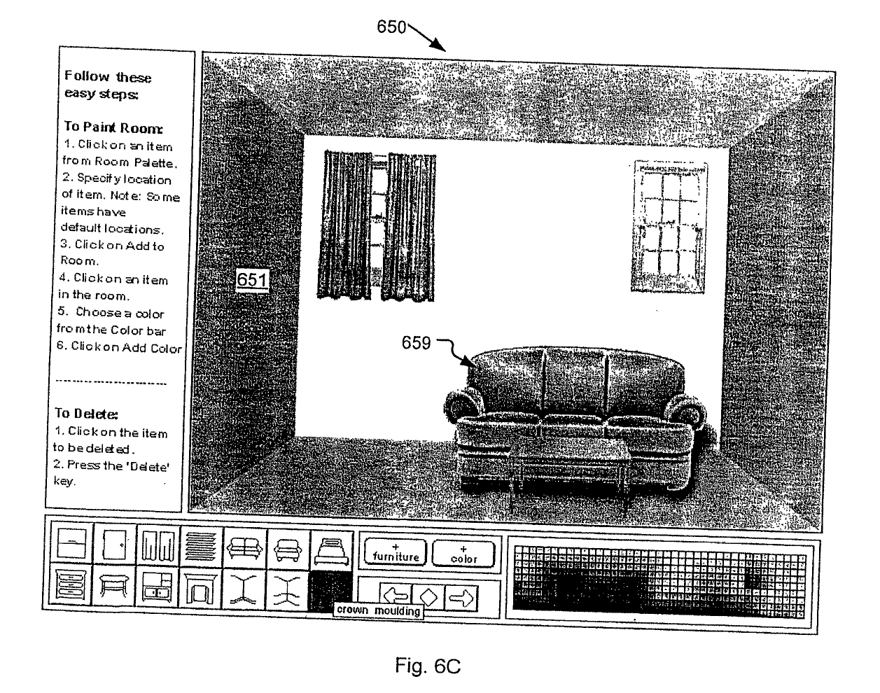

To provide operations needed by the decorating system, the web server database 203 is configured with data detailing different design and decorating elements that can be added to a room and manipulated by a user. This data may include data detailing room structures and furnishings (“structural objects”), as well as decorative materials such as paint, wallpaper, and fabric. Decorating system software uses the data in the database 203 to create a graphical representation of a building space that has been custom-decorated by a user. A user interface 600 used by an exemplary decorating system software program is shown in FIGS. 6A-6C. The interface images in FIGS. 6A-6C show an image of a room that is displayed with different structural objects and decorative materials.

To generate a visual image for a custom design and decorating project, decorating system software processes data specifying (i) structural objects, (ii) decorative materials, and (iii) the relationships between the structural objects and the decorative materials (object-material relationship data). A description of this data follows:

Structural Object Data

Structural object data is used to model physical objects forming a building space (e.g., a room) and objects arranged within that space. Structural object data can include three-dimensional (3D) models of building structures such as walls, windows, doors, and molding, as well as 3D models of room furnishings such as couches, tables, beds, curtains, lamps, and desks, and the relative sizes of each modeled object.

Decorative Material Data

Decorative material data models visual characteristics of decorative materials that can form or be applied to structural objects. Materials modeled by the decorative material data can include, among other things, paint, wallpaper, fabric, and natural materials such as wood and stone. Decorative material data may include color data, bump maps, texture maps, transparency and reflectivity information, color images, and other data used to model visual characteristics of decorative materials and used to apply those visual characteristics to the modeled structural objects. As an example, decorative material data for paint may include color, transparency, reflectivity, and surface texture information, while decorative material data for fabric may include color and pattern data.

Object-Material Relationship Data

Object-material relationship data is used to specify relationships between structural objects and decorative materials. For example, object-material relationship data may identify the particular paint that has been applied to a particular wall in a room design, all of the fabric materials that can be applied to a particular “couch” object, and all of the types of paint that may be applied to a structural object made of metal (e.g., a radiator). The object-material relationship data can also specify other characteristics of particular structural objects, decorative materials, and their combinations. For example, the object-material data may identify the vendors and vendor prices for a particular couch covered with a particular fabric material. As another example, the object-material relationship data may indicate the coverage area of a particular type of paint when the paint is applied to a concrete wall and when it is applied to a smooth surface. In some implementations, object-material relationship data can associate a single structural object with multiple decorative materials.

Structural object data, decorative material data, and object-material data are also referred to herein as “modeling data.” In various implementations, modeling data may, in whole or in part, be embodied in software code that can be downloaded from the web server (e.g., database 203) to a web client. That is, modeling data may be embodied in a software algorithm or in a software data structure instead of, or in addition to, storing modeling data in a separate database table, structure, or file system. Database 203 implementations can also make other changes to the organization of the modeling data. For example, in a relational database implementation, each permitted structural object and decorative material combination may be represented by its own database record which combines the structural object, decorative material, and object-material data for that combination. In other implementations, pointer data may link different types of modeling data. Still other data combinations and re-organizations are possible.

Structural object data can include a three-dimensional (3D) representation of each object, and the decorative material data can include data allowing visual characteristics of particular decorative materials to be mapped onto those 3D representations. Suitable data structures and techniques for 3D representation of objects and the mapping of visual characteristics to those objects are described in Computer Graphics, Principles and Practice: Second Ed. in C, by Foley, van Dam, Feiner, and Hughes, Addison-Wesley Pub Co; ISBN: 0201848406, and in references cited therein. Other techniques for modeling objects and mapping visual characteristics to them also are known in the field of computer-generated imaging, and such techniques may be applied in the decorating system described herein.

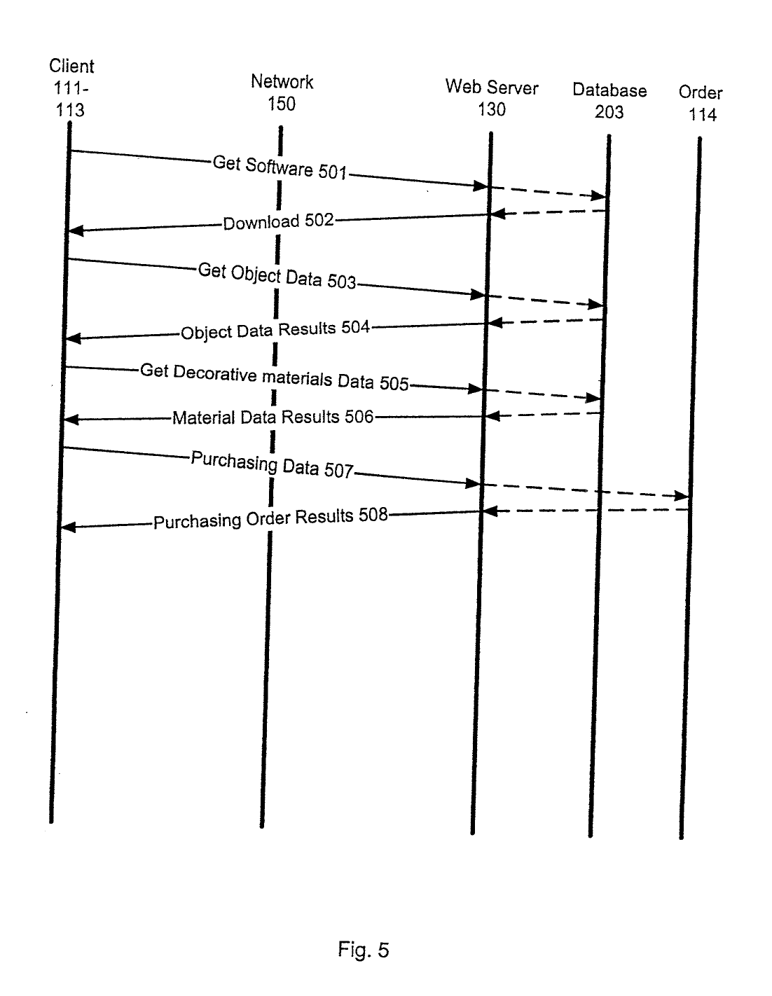

The decorating system software may include modeling and rendering software that is executed at a web client (the “modeling software”). Advantages of executing the modeling software at the web client may include improved performance and response times and the ability to support a large number of web clients. Referring to FIGS. 1 and 5, the modeling software may be downloaded from server 130 to the web client when a hypertext link on a web page is selected at the client. When the hypertext link is selected, the client computer's browser software sends a HTTP message 501 to the server 130 requesting the modeling software. The modeling software is then downloaded 502 from the web server to the client and executed. Depending on the particular programming language and tools selected in an implementation, execution of the modeling software may be performed using a Java virtual machine, the native operating system of the client computer, and/or other software and hardware resources of the client computer.

When the modeling software is executed, it displays a graphical user interface (GUI) that permits a user to input data and manipulate objects using a keyboard, mouse, and/or other input devices, and to receive output. FIGS. 6A-6C show an exemplary modeling software interface. FIG. 6A shows a view of the interface prior to the addition of structural objects by a user. FIG. 6B shows a view of the interface with structural objects displayed in a wire-frame view. Wire-frame views may be used to display objects that have not been associated with decorative materials and/or may be used to improve user-perceived performance of the interface. FIG. 6C shows a view of the interface in which decorative materials have been applied to structural objects.

The interface 600 allows access to operations implemented by the modeling software using graphical user interface (GUI) tool buttons 601-618. The tool buttons include structural object buttons 601-612 that can be used to add structural objects (such as a window, door, curtain, blinds, couch, chair, bed, dresser, table, cabinet, fireplace and different types of molding to a room, respectively) to the image viewed in an image output portion 650 of the interface.

When a structural object button 601-612 is selected, a query 503 may be sent from the web client to the web server or directly to the database 203 to obtain the relevant structural object data. The query can include database query parameters and commands used to retrieve relevant structural objects from the database 203. For example, when the couch object button 605 is selected, a query 503 containing a structured query language (SQL) program may be sent (directly or via the web server) to the database 203. The SQL program may include SQL code to retrieve database records containing a “couch” identification code in a particular field of a database record. In response, all the relevant database records for couch structural data objects as implied by the request are returned 504 from the database to the modeling software. In other implementations, structural object data may be included with the software download 502 to reduce the need for subsequent data transfers (e.g., 503-504).

If multiple structural objects are associated with the same structural object button (e.g., different styles of couches may be associated with the couch object button 605), a menu, GUI dialog box, or other listing may be displayed to allow the user to select a particular one of the multiple objects. To help the user in selecting an object from such a listing, the multiple objects may be listed along with a picture of each object (e.g., each object may be identified by name or by a code number and shown alongside a thirty-two by thirty-two pixel “thumb-nail” picture). Alternatively, a default structural object may be added to the view of the building space shown in the output area 650 of the interface, and the user may thereafter select a more specific object. For example, when the couch button 605 is selected, a popular style of couch may, by default, be added to the view shown in the interface 600. The user may thereafter select the default couch object (e.g., by using a mouse-based point-and-click interface) and change it by selecting a different style of couch from a menu, pop-up menu, dialog box, or other input interface. The default structural object, and the order in which multiple objects are listed to a user, also can be determined based on priority levels assigned to each object by the web server. Priority-level information may be included in the response 504 and may be determined by the web server based on, e.g., sales numbers, profitability, stock levels, and/or preferred manufacturer or vendor arrangements. For example, the operator of the web site hosting the design application may sell product placements whereby a manufacturer can purchase the right to have its products appear as a default product. Still other methods to select default objects (e.g., random selection) are possible. The default object also can be determined using a separate query to the web server 130 or its database system 203.

When a structural object is added to a room, it may be placed in a default location (e.g., the center of the room or an available empty space), or the user may use a GUI pointer to indicate the placement of the object. The object may thereafter be selected by the user (e.g., using a point-and-click GUI interface) and manipulated. Object manipulations include moving, copying, and deleting the objects as well as changing properties of the objects such as the decorative material applied to the object. For example, when couch 659 (FIGS. 6B, 6C) is selected, the user may indicate (e.g., point, click, and drag the couch to) a new location in the view 650 and, via a menu, dialog box, or other GUI input means, may be presented with options to change the decorative material (i.e., fabric) applied to the couch.

The interface 600 also includes GUI buttons 613-614 and a color picker 618 that allow the user to change the decorative material applied to a structural object. The color picker 618 displays small samples of the different colors that are available for an object and the displayed colors may differ depending on the particular object selected. For example, when a wall structural object 651 is selected, the color picker 618 may display all available paint colors; when a couch structural object 659 is selected, the color picker may display all available fabric colors and patterns. When a structural object is selected, a query 505 may be sent to the web server or directly to the database to retrieve a listing of available colors and/or patterns for a particular object.

Colors and patterns of decorative materials, as displayed using a computer video monitor or printer, can provide a useful approximation of an actual color or pattern of a decorative material. However, due to limitations in, among other things, the phosphors used in color monitors and in the toner, dyes, and inks used in computer printers, precise color matching may be difficult. To enable a more precise assessment of decorative materials by a user, implementations may provide the users with physical sample charts containing samples of the actual decorative material products. Such sample cards may be distributed to users by mail, at locations such as paint, fabric, and decorating stores, or by other methods. Implementations can also provide automated color matching by analysis of a user's sample color. Color matching and analysis can be provided using a digital imaging device (e.g., a color image scanner, digital camera, or other a video signal capture device) coupled to the client computer. For example, a color image scanner can be used to scan a fabric sample and, based on the color of the scanned sample, the modeling software may display matching paint or fabric colors or may suggest visually compatible choices. The ability to match colors or patterns of digitally imaged samples may be limited by the color fidelity of the digital imaging device, device color calibration using, e.g., International Color Consortium (ICC) profiles and Color Management Module (CMM) such as implemented in Apple ColorSync®, MicroSoft ICM 2.0®, Kodak Digital Science Color Management System®, or device color calibration and color management system.

In addition, when a user selects a particular decorative material for one structural object, the modeling software may make recommendations of compatible decorative materials for other structural objects subsequently selected/added during the decorating session.

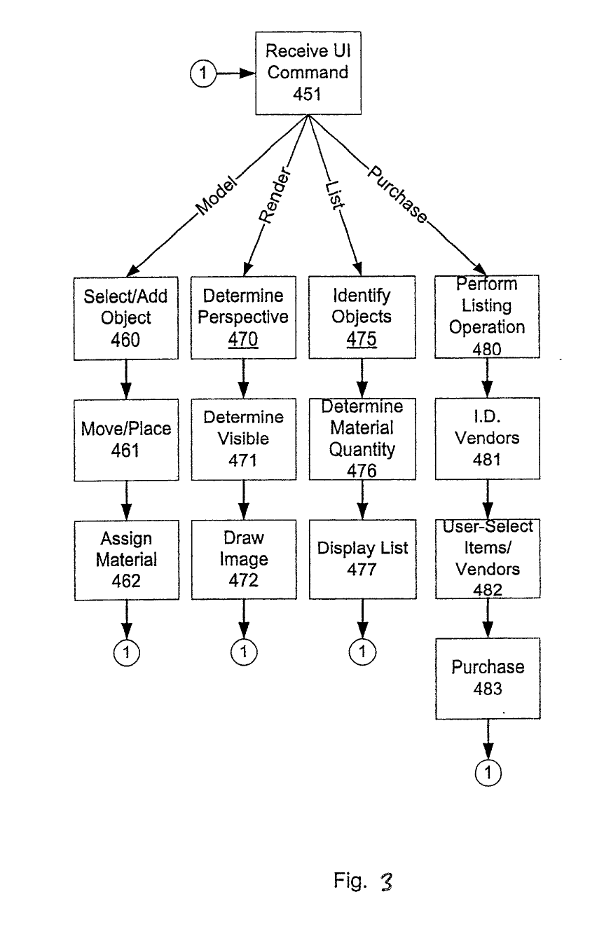

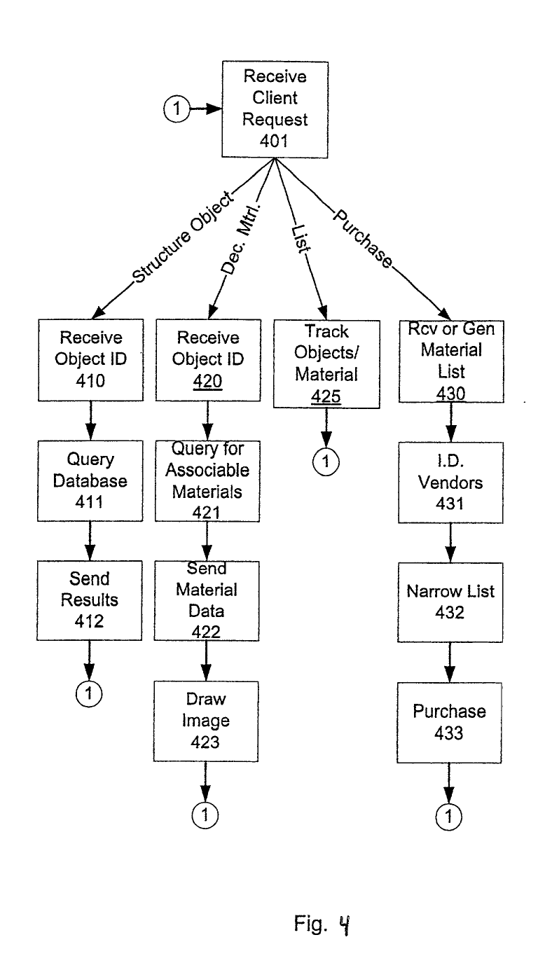

FIG. 3 shows additional details of exemplary modeling software operations executed at a web client, and FIG. 4 shows additional details of web server operation responsive to the operations of FIG. 3. The client-executed modeling software can include modeling 460-462, rendering 470-472, object listing 475-477, and purchasing 480-483 operations that are performed using data obtained from, or exchanged with, the web server.

Modeling operations 461-462 are executed at the client when a user adds a structural object (e.g., by selecting a tool button 601-612) to a room being decorated, or otherwise manipulates objects displayed by the interface 600. When a structural object is added, a request 503 may be sent from the client to the server to obtain modeling data from the server. The request 503 may include an identifier of the object or category of object to be added or manipulated. Upon receiving 401 the request 503, the web server queries 411 the database 203 to obtain relevant modeling data. The object or object category identifier in the request 503 may be used as a key to obtain the relevant data. For example, when the “add couch” button 605 is selected, the request 503 may include a category identifier indicating that all “couch” structural object records should be obtained from the database 203. The query results are then returned 412 to the client in a message 504. In some implementations, the query 503 may be sent directly to a database server and steps 401-412 may be performed as operations of the database server.

If the results 504 received by the client include data for multiple structural objects, the client computer may provide an interface (e.g., a menu or listing) allowing selection of the desired object. The desired object may then be placed in the space being designed or decorated, arranged by the user, and assigned a decorative material 462. In some implementations, the decorative materials that are assignable to a particular structural object may be identified by the structural object data or by programming in the modeling software. For example, structural object data returned 504 by the web server for “wall” objects may indicate that all paints and all paint colors may be applied to the wall object. The modeling software may include programming or data that allows the identified decorative material to be rendered (470-472, explained below) without a further query to the web server. In other implementations, a query 505 is sent to the web server (or database 203) to obtain decorative material data for an object. The query 505 may include an identifier of the particular object (e.g., “Couch Model XYZ123”) and/or the object category (e.g., “Couch”) which is received 420 at the web server and used to perform a database query operation 421 for decorative materials that can be associated with the identified object or object category. The decorative material data is then sent 506 to the web client.

When a structural object is added or manipulated (such as by changing its position or associated decorative material), the web client renders a new image of the building space (i.e., room) being decorated and displays the image in the output area 650 of the interface 600. To render the new image, the modeling software executes an image rendering algorithm that can include operations such as determining a viewer's perspective of the decorated space 470, determining structural objects or portions of structural objects that are visible from that perspective 471, and drawing the image 472 by using the decorative material data and structural object data to determine the visual characteristics of the visible structural objects.

A user may want to obtain a listing of materials being used in a decorating project. The interface 600 may include a GUI menu or button, or may respond to keyboard input to initiate operations 475-477 to generate a listing of structural objects and decorative materials. For example, when a pre-assigned function key is pressed on a client computer's keyboard, the modeling software at that client computer can analyze the current state of its modeling data to determine a listing of the structural objects and decorative materials being used for a particular decorating project 475. In addition to generating a hard copy of the listing, the listing for a decorative session can be stored for use during a subsequent decorative session. Such a listing can also be used to communicate the results of a decorating session to another user. For example, the listing for a decorating session performed by an interior decorator can be transmitted to a client for review and/or further manipulation during a subsequent decorating session performed by the client.

In some implementations, an amount of materials needed for a project, and their cost, can also be determined 476. For example, if a design includes three hundred square feet of wall space covered in a particular paint, and the decorative material data for that paint indicates a coverage of fifty square feet per quart, availability in quart size containers at $8/quart, and availability in gallon size containers at $20/gallon, then the materials listing data that is generated may indicate that six quarts of the paint (one gallon plus two quart size containers) are needed by the user, and that the cost of the paint is $20+$8+$8=$36. Cost calculation features can aid, e.g., contractors and decorators in providing project cost estimates to a client. Cost calculation features can also be used for comparative cost estimates. Comparative cost estimates permit a user to easily evaluate cost impacts of design changes. The available quantities and corresponding prices of materials used in calculating the cost of a decorating session may be based on information automatically gathered by the web server from other web sites (e.g., maintained by the suppliers of such materials). The user may be presented with options and/or recommendations of particular brands with relative qualities and/or prices of materials identified from which to choose in generating the cost. In addition, the cost of a decorating session may also include estimates of corresponding labor charges.

Some structural objects and decorative materials may be inherently interrelated (e.g., the decorative material is a part of the structural object as that object is commonly purchased or constructed). In such cases, a materials listing may include a single identifier to identify both the object and its associated material. For example, the materials listing can include a single product identifier to identify both a particular style couch and a particular selection of fabric covering that couch. The listing of the materials may then be displayed to the user 477. In some implementations, the listing of materials can be generated by the web server instead of at the web client. For example, as a user designs a room, messages can be sent to the web server allowing the web server to track 425 the structural objects and decorative materials selected by the user. The web server can use this tracking data to generate a listing of all of the structural objects and decorative materials used in a user's decorating project.

Implementations can include automated purchasing of structural objects and decorative materials. Automated purchasing is provided by interfaces to one or more vendor ordering systems (114 in FIG. 1). The interfaces may be direct interfaces from the web clients 111-113 to the ordering system 114 or an indirect interface (e.g., from a web client to the web server and then from the web server to the ordering system 114). Automated purchasing allows orders for structural objects and materials to be automatically submitted to the appropriate vendor ordering systems. To automate purchasing, a listing of materials is first generated 480 (e.g., via operations 475-476). Vendors for the selected items are then identified 481 using information in previously obtained modeling data or by querying (505-506) the database 203 to obtain vendor information. If multiple vendors are available, the different vendors may be listed along with their prices, stock availability, location, and/or other characteristics. The user may then be given the opportunity to select or omit particular items from the list and/or to select the desired vendor 482 for each of the items being ordered. Purchasing information (such as a credit card number or other payment information and delivery or pick-up instructions) may then be obtained from the user 483, and messages 507-508 are exchanged with the web server or directly with the purchase ordering system 114 to order the desired merchandise. Furthermore, based on the geographic location of the user and based on periodically updated data of stores, inventories, and prices, the user may be offered a list of stores in the user's geographic area where such purchases can be made.

Alternative Embodiments

In the embodiment described in the context of FIGS. 3-4, during a room decorating session, each time the user selects a new structural object or a new decorative material, a request is transmitted over the Internet from the client computer to the web server, which retrieves corresponding information (e.g., an appropriate data file) from the web server's database and transmits that information back over the Internet to the client computer, which then uses that information to update the display of the room accordingly (e.g., by adding the new structural object to the room or applying the new decorative material to an existing structural object). As suggested earlier, however, according to alternative embodiments of the present invention, data, such as structural object data and decorative material data, may be included with the initial download processing to reduce the need for subsequent data transfers. These alternative embodiments may correspond to alternative interpretations of the processing shown in FIG. 5.

According to one possible implementation, the modeling software that is downloaded over the Internet from the web server to the client computer at step 502 includes a Java applet that is automatically executed when it arrives at the client computer. When it is launched at the client computer, the Java applet automatically transmits requests from the client computer over the Internet to the web server for the web server to access and transmit specific (e.g., compressed) data files from the web server's database.

In particular, in the context of FIG. 5, the Java applet may automatically transmit a request 503 from the client computer over the Internet to the web server for structural object data. In response, the web server accesses its database and transmits one or more data files for all of the different structural objects that are supported by the current version of the web site, over the Internet to the client computer at step 504. Similarly, the Java applet may automatically transmit a request 505 from the client computer over the Internet to the web server for decorative material data. In response, the web server accesses its database and transmits one or more data files for all of the different decorative materials that are supported by the current version of the web site, over the Internet to the client computer at step 506. In such an implementation, the decorating of the room by the user during a decorating session begins only after all of the structural object and decorative material data files have been downloaded onto the client computer (i.e., after the completion of step 506).

In preferred implementations, in addition to the structural object and decorative material data files, three additional data files are transmitted from the web server over the Internet to the client computer:

(1) a building space GUI file corresponding to a GUI for the undecorated building space itself (e.g., an undecorated version of room 650 in FIG. 6B),

(2) a structural object GUI file corresponding to a GUI for the available structural objects (e.g., corresponding to tool buttons 601-617 of FIG. 6A), and

(3) a decorative material GUI file corresponding to a GUI for the available decorative materials (e.g., corresponding to color chart 618 of FIG. 6A). Depending on the implementation, these three GUIs may be displayed as a single integrated user interface (as in FIGS. 6A-C) or as three distinct windows that, for example, can be moved, reduced, and/or hidden independent of one another using the operating system on the client computer.

The use of these distinct data files for the building space, the structural objects, and the decorative materials allows the decorating web site to be updated without having to change the underlying modeling software. For example, the basic plan of the building space can be changed by providing a different building space GUI file in the web site database. Similarly, additional structural objects can be supported by adding corresponding structural object data files and altering the structural object GUI file. Likewise, different decorative materials can be supported by providing a different decorative material GUI file.

After all of the various data files have been downloaded by the web server over the Internet to the client computer, the user can then proceed to perform a decorating session for the building space without requiring any subsequent communications over the Internet between the client computer and the web server. In particular, with all of the modeling software and data files resident on the client computer (e.g., in RAM), all subsequent processing can be implemented locally on the client computer. As a result, the decorating session can proceed much more efficiently than if the client computer must transmit a request over the Internet to the web server every time a new structural object or a new decorative material is selected by the user, followed by a download of the corresponding data file from the web server over the Internet to the client computer, all of which delays the update of the display of the decorated room by the modeling software.

Rather, in these alternative implementations, every time the user selects a new structural object or a new decorative material, the modeling software is able to update the room display 650 relatively quickly by accessing data files that are already resident on the client computer. Moreover, in preferred implementations, each structural object data file corresponds to an undecorated structural object. Any decorative material (e.g., a color) selected by the user for a particular structural object is applied programmatically by the modeling software in real time. This limits the number of different data files that need to be downloaded over the Internet to the client computer when the web site is initially accessed by the user, thereby keeping the initial download time to an acceptable duration (e.g., less than one minute for a 28.8 Kbps Internet connection).

In some cases, the appearance of a structural object (or even a decorative material) may depend on its location within the building space. For example, the appearance of a fireplace may depend on whether it is placed on the left wall or the right wall of room 650. For implementations in which structural objects are represented by 3D data files, the modeling software can apply appropriate processing (e.g., rotation and magnification) to the 3D data based on the location selected for the structural object. For implementations in which structural objects are represented by 2D data files, the modeling software can still apply appropriate processing (e.g., image reversal) based on the selected location. In either case, such capability minimizes the number of different data files that need to be downloaded to the client computer. For example, only one structural object data file is required for a fireplace, as opposed to requiring one data file for a left-wall fireplace and a different data file for a right-wall fireplace.

In addition, in certain implementations, the appearance of a decorative material selected for certain structural objects will depend on the location of the structural object. For example, when a user selects a particular color to be applied to the walls and ceiling of the building space, the exact shading of the color in the displayed building space will vary between the ceiling, the side walls, and the back wall to present a more realistic view of the decorated building space to the user.

In addition, in certain implementations, at least some of the structural objects, such as chairs, sofas, and the like, are represented in the corresponding data files as a rectangular image containing a two-dimensional perspective view of the structural object. In general, one or more regions of each such rectangular image will correspond to “background” that is outside of the boundaries that define the structural object itself (e.g., the outline of a chair). When the user selects such a structural object to be added to the building space during a decorating session, the modeling software generates an updated display of the building space in which only the structural object itself is displayed. In particular, the modeling software treats as transparent the background regions of the corresponding rectangular image that fall outside of the structural object itself. This enables only the structural object along with its applied decorative material to be displayed without having the rest of the rectangular image (i.e., the background) obscure other structural objects in the building space.

In certain implementations, the modeling software displays certain structural objects based on the order in which those objects are selected, while other structural objects are displayed based on the nature of the structural object. For example, during a decorating session, if the user first adds a sofa to the building space and then adds a chair at the same general location in the building space, the modeling software will generate a display in which the image of the chair overlays the image of the sofa such that the chair appears to be in front of the sofa in the view of the building space presented to the user, because the chair was added after the sofa. If, on the other hand, the sofa were added after the chair, then the modeling software would generate a display in which the image of the sofa overlays the image of the chair. Depending on the relative size and positioning of such structural objects, it is possible that the image of a later-added structural object could completely obscure the image of a previously added structural object.

On the other hand, the modeling software will display other types of structural objects independent of the order in which they are added. For example, even if a fireplace were added after a sofa, the modeling software will always display the fireplace behind the sofa, because the nature of a typical fireplace is that it is built into the wall of a building space.

Depending on the implementation, the modeling software may handle other situations differently. For example, if the user adds a fireplace to a particular wall of the building space and then attempts to add a door at a corresponding location in the building space, the modeling software may either (1) refuse to add the door until the fireplace is deleted, (2) automatically delete the fireplace and add the door, or (3) add the door either behind or in front of the fireplace even though such a design is “impossible” or at least “impractical,” depending on the particular implementation of the modeling software.

Depending on the implementation, the user may be provided with the ability to make a purchase based on the results of a decorating session. In that case, the purchasing data will be transmitted from the client computer over the Internet to the web server as in step 507 of FIG. 5, with the corresponding purchasing order results transmitted from the web server over the Internet to the client computer as in step 508. However, between the initial downloading of all of the various data files (which ends after step 506) and the subsequent transmission of purchasing data (at step 507), all processing for a particular decorating session can be implemented locally on the client computer without requiring any Internet transmissions to or from the web server.

In some implementations, automatic purchasing can be implemented using web “cookies” to exchange data between design and decorating components and a purchasing system. Web cookies are a HTTP protocol mechanism allowing files that are generated at a web server to be stored at a web client for future retrieval by that web server or by another web server. Files may also be locally generated at a client and stored as “web cookies” for retrieval by another web server. Web cookies can contain, e.g., user name information, structural objects used in a decorating project, and other information generated as the user interacts with the modeling software and server 130. Of course, information can also be exchanged using other protocols to transfer information directly to the purchasing system 114 or to the server 130 for relay to the purchasing system. Example protocols include HTTP, FTP, TCP/IP, and SMTP.

The invention has been described in the context of a web site that enables a user to perform decorating sessions on a building space, such as an empty room. In alternative implementations, the web site may provide each user with a number of different types of rooms (e.g., living room, bedroom, kitchen), where the set of available structural objects and decorative materials may differ from room to room (e.g., a refrigerator may be available in a kitchen and a bed may be available in a bedroom, but not vice versa). As a default, the web site may initially launch with a particular type of room (e.g., a living room) or a generic room with all possible structural objects and decorative materials available.

The invention may be implemented in digital electronic circuitry, or in computer hardware, firmware, software, or in combinations of them. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output. The invention may advantageously be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application-specific integrated circuits).

Visualization and rendering applets as well as other software and applets may be constructed from a programming language that executes in a run-time environment provided by the browser application at the client computer. For example, the Java® programming language from Sun Microsystems, Inc., allows Java applets to be stored at a web server and attached to web pages for execution by a Java interpreter or Java just-in-time compiler. Java Applets may be formed from multiple Java Classes. Java Classes include executable Java code that can be downloaded from a server in response to a dynamically generated request to execute the class (a module execution request). If a Java Class is not available to a Java interpreter when an executing applet attempts to access functionality provided by the Class, the Java interpreter may dynamically retrieve the Class from a server. Other programming languages, such as Microsoft Visual Basic® or Microsoft Visual C++®, may also be used to create applet-like software modules, such as Microsoft ActiveX™ controls.

A number of embodiments of the present invention have been described. Nevertheless, it will be understood that various modifications may be made without departing from the spirit and scope of the invention. For example, a web client may be a client computer configured with a web browser, a web browser together with an applet program or other software program. Web server 130 and database 203 may be provided by different programs executing (multitasked) on a single computer, by an integrated program on a single computer, or by software executing on multiple computers that are co-located or geographically diverse. The web server 130 may be provided on a single computer that communicates with multiple database servers 203 distributed across the Internet. The term “decorating system” may refer to a distributed design and decorating facility made up of one or more of the following components: downloadable software components, server-hosted components, and stand-alone software applications. Implementations may include a default set of structural objects in a building space to be decorated; for example, walls, ceilings, and windows may be included to form a bare room that a user may then decorate. Particular structural objects and/or decorative materials may be “required” within a room; for example, a paint vendor may require a user to select at least one type of paint before a purchase order can be generated. In some implementations, two-dimensional images of structural objects may be used in place of, or in addition to three-dimensional models. Accordingly, other embodiments are within the scope of the following claims.

What is claimed is:

1. A method for enabling a user to perform a decorating session for a space, comprising the steps of:
(a) receiving, at a web server, a request from a remote client computer for access to a decorating web site supported by the web server; and
(b) transmitting, in response to the request, software from the web server to the client computer, wherein, when executed on the client computer, the software enables the user to perform the decorating session for the space.

2. The invention of claim 1, wherein the software enables the user to perform the decorating session for the space without any subsequent communication between the client computer and the web server.

3. The invention of claim 1, wherein the software comprises an applet, which, when executed on the client computer, automatically transmits one or more additional requests to the web server for one or more data files to be downloaded to the client computer.

4. The invention of claim 3, wherein the one or more data files comprise:
(1) a space graphical user interface (GUI) file corresponding to a GUI for the space to be decorated;
(2) a structural object GUI file corresponding to a GUI identifying one or more structural objects that can be added to the space by the user during the decorating session;
(3) a structural object data file for each structural object identified in the structural object GUI; and
(4) a decorative material GUI file corresponding to a GUI identifying one or more decorative materials that can be applied to the one or more structural objects during the decorating session, wherein the software causes the space GUI, the structural object GUI, and the decorative material GUI to be displayed on a display device configured to the client computer.

5. The invention of claim 4, wherein, when the user selects a particular decorative material for a particular structural object, the software applies the decorative material to the structural object in real time to update the display of the space GUI.

6. The invention of claim 5, wherein the software controls the appearance of the decorative material based on location of the structural object in the space GUI.

7. The invention of claim 4, wherein the software provides the user with a plurality of possible locations for a particular structural object represented by a single data file, wherein the software controls the appearance of the structural object based on the location in the space GUI selected by the user for the structural object.

8. The invention of claim 4, wherein at least one structural object data file corresponds to a rectangular image of the corresponding structural object and the software treats any region of the rectangular image outside of the structural object as transparent when displaying the structural object in the space GUI.

9. The invention of claim 4, wherein the software controls the display of a first type of structural object based on relative order in which different structural objects are selected during the decorating session, while controlling the display of a second type of structural object independent of relative order in which different structural objects are selected.

10. The invention of claim 1, wherein the software enables the user to generate a listing documenting results of the decorating session for use in a subsequent decorating session performed by either the user or another user.

11. The invention of claim 1, wherein the software is able to generate a cost associated with results of the decorating system.

12. The invention of claim 1, wherein the software enables the user to make a purchase based on results of the decorating session.

13. The invention of claim 1, wherein:
the software enables the user to select from a plurality of structural objects to be added into the space during the decorating session; and
the software enables the user to select from a plurality of decorative materials to be applied to the selected structural objects during the decorating session.

14. The invention of claim 13, wherein the software is able to identify at least one of the decorative materials to match a sample represented by a user-provided scanned image loaded onto the client computer.

15. The invention of claim 13, wherein the software provides the user with a plurality of possible locations in the space GUI for a particular structural object.

16. The invention of claim 15, wherein the software controls the appearance of the particular structural object based on the location in the space GUI selected by the user.

17. A machine-readable medium, having encoded thereon program code, wherein, when the program code is executed on a machine, the machine implements a method for enabling a user to perform a decorating session for a space, comprising the steps of:
(a) receiving, at a web server, a request from a remote client computer for access to a decorating web site supported by the web server; and
(b) transmitting, in response to the request, software from the web server to the client computer, wherein, when executed on the client computer, the software enables the user to perform the decorating session for the space.

18. An apparatus for enabling a user to perform a decorating session for a space, comprising:
(a) means for receiving, at a web server, a request from a remote client computer for access to a decorating web site supported by the web server; and
(b) means for transmitting, in response to the request, software from the web server to the client computer, wherein, when executed on the client computer, the software enables the user to perform the decorating session for the space.

19. An apparatus for enabling a user to perform a decorating session for a space, comprising a web server configured with a database, wherein:
the web server is configured to receive a request from a remote client computer for access to a decorating web site supported by the web server; and
the web server is configured, in response to the request, to access software from the database and transmit the software to the client computer, wherein, when executed on the client computer, the software enables the user to perform the decorating session for the space.

20. A method for enabling a user to perform a decorating session for a space, comprising the steps of:
(a) receiving, at a web server, a request from a remote client computer for access to a decorating web site supported by the web server; and
(b) executing, in response to the request, software to enable the user to perform the decorating session for the space, wherein, during the decorating session, the user is able to:
(i) select one or more structural objects from a plurality of available structural objects for display in the space; and
(ii) select a decorative material from a plurality of available decorative materials to be applied to each selected structural object independent of the decorative materials selected for any other structural object.

21. The invention of claim 20, wherein the software is executed at the client computer.

22. The invention of claim 20, wherein the software accesses:
(1) a space graphical user interface (GUI) data file corresponding to a GUI for the space to be decorated;
(2) a structural object GUI data file corresponding to a GUI identifying the plurality of available structural objects that can be added to the space by the user during the decorating session;
(3) a structural object data file for each structural object identified in the structural object GUI; and
(4) a decorative material GUI file corresponding to a GUI identifying the plurality of available decorative materials that can be applied to the available structural objects during the decorating session, wherein, during the decorating session, the software causes the space GUI, the structural object GUI, and the decorative material GUI to be displayed on a display device configured to the client computer.

23. The invention of claim 20, wherein, when the user selects a particular decorative material for a particular structural object, the software applies the decorative material to the structural object in real time to update the display of the space.

24. The invention of claim 20, wherein the software controls the appearance of the decorative material based on location of the structural object in the space.

25. The invention of claim 20, wherein the software provides the user with a plurality of possible locations for a particular structural object represented by a single data file, wherein the software controls the appearance of the structural object based on the location in the space selected by the user.

26. The invention of claim 20, wherein at least one structural object is represented by a rectangular image of the structural object and the software treats any region of the rectangular image outside of the structural object as transparent when displaying the structural object in the space.

27. The invention of claim 20, wherein the software controls the display of a first type of structural object based on relative order in which different structural objects are selected during the decorating session, while controlling the display of a second type of structural object independent of relative order in which different structural objects are selected during the decorating session.

28. The invention of claim 20, wherein the software enables the user to generate a listing documenting results of the decorating session for use in a subsequent decorating session performed by either the user or another user.

29. The invention of claim 20, wherein the software is able to generate a cost associated with results of the decorating system.

30. The invention of claim 20, wherein the software enables the user to make a purchase based on results of the decorating session.

31. The invention of claim 20, wherein the software is able to identify at least one of the decorative materials to match a sample represented by a user-provided scanned image loaded onto the client computer.

32. The invention of claim 20, wherein the software provides the user with a plurality of possible locations in the space for a particular structural object.

33. The invention of claim 32, wherein the software controls the appearance of the particular structural object based on the location in the space selected by the user.

34. The invention of claim 20, wherein the decorating web site enables the user to select the space from a plurality of different space types, wherein the available structural objects for the space is a function of the space type.

35. A machine-readable medium, having encoded thereon program code, wherein, when the program code is executed on a machine, the machine implements a method for enabling a user to perform a decorating session for a space, comprising the steps of:
(a) receiving, at a web server, a request from a remote client computer for access to a decorating web site supported by the web server; and
(b) executing, in response to the request, software to enable the user to perform the decorating session for the space, wherein, during the decorating session, the user is able to:
(i) select one or more structural objects from a plurality of available structural objects for display in the space; and
(ii) select a decorative material from a plurality of available decorative materials to be applied to each selected structural object independent of the decorative materials selected for any other structural object.

36. An apparatus for enabling a user to perform a decorating session for a space, comprising:
(a) means for receiving a request from a remote client computer for access to a decorating web site supported by the web server; and
(b) means for executing software to enable the user to perform the decorating session for the space, wherein, during the decorating session, the user is able to:
(i) select one or more structural objects from a plurality of available structural objects for display in the space; and
(ii) select a decorative material from a plurality of available decorative materials to be applied to each selected structural object independent of the decorative materials selected for any other structural object.

37. An apparatus for enabling a user to perform a decorating session for a space, comprising a web server configured with a database, wherein:
the web server is configured to receive a request from a remote client computer for access to a decorating web site supported by the web server; and
the web server is configured, in response to the request, to access software from the database, wherein, when the software is executed, the software enables the user to perform the decorating session for the space, wherein, during the decorating session, the user is able to:
(i) select one or more structural objects from a plurality of available structural objects for display in the space; and
(ii) select a decorative material from a plurality of available decorative materials to be applied to each selected structural object independent of the decorative materials selected for any other structural object.
